(19) United States
(12) Patent Application Publication
(10) Pub. No.: US 2010/0309672 A1
(43) Pub. Date: Dec. 9, 2010

(54) Clamping member for connecting light cover to light housing

(76) Inventor: Chen-Han Hsieh, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/457,224

(22) Filed: Jun. 4, 2009

(51) Int. Cl. F21V 21/08

(52) U.S. Cl. 362/396

(57) ABSTRACT

A light assembly includes a housing including two frames and two covers are respectively connected to the frames by multiple clamping members. Each of the frames includes at least one first wall which has at least one notch defined therein and each of the covers includes at least one second wall which includes at least one slot. Multiple clamping members connect the covers to the frames and each clamping member includes a first plate, two second plates and a connection portion connected between the first and second plates. A positioning plate extends from the connection portion and includes a ridge extending therefrom. The at least one first wall of each frame is located between the first and second plates and the positioning plate is located within the at least one notch and the ridge is engaged with the at least one slot of the at least one cover.

### FIELD OF THE INVENTION

The present invention relates to a light assembly, and more particularly, to a clamping member for connecting the light housing and the light cover.

### BACKGROUND OF THE INVENTION

A conventional light assembly and generally includes a light frame with which the light bulb is connected and a reflection part is connected to the frame so as to concentrate the light beam. An anti-glare cover is also connected to the frame and provides an anti-glare function. The reflection part and the anti-glare cover are connected to the frame by their specifically designed clamping means.

A conventional light assembly known to applicant includes a reflection cover, a light frame and multiple clamping members, wherein each of the clamping members has an elongate body, multiple clamping plates and a positioning plate. The positioning plate is first connected to the light frame and the clamping plates are then clamped to the reflection cover so as to connect the reflection cover and the light frame. However, the clamping members cannot be secured the light frame and are loosened after a period of time of use. The loosened clamping members make the connection between the reflection cover and the light frame to be unstable.

The present invention intends to provide a clamping member which securely connects the light frame and the light cover to improve the shortcoming of the conventional clamping members.

### SUMMARY OF THE INVENTION

The present invention relates to a light assembly comprises a housing, at least one cover and at least one clamping member, wherein the at least one housing includes at least one frame connected thereto and the at least one frame includes at least one first wall. The at least one first wall has at least one notch defined therein. The least one cover includes at least one second wall which includes at least one slot. The at least one clamping member includes a first plate, two second plates and a connection portion which is connected between two respective ends of the first and second plates so as to define a gap between the first plate and the two second plates. A positioning plate extends from the connection portion and is located between the two second plates. A ridge extends from a side of the positioning plate. The at least one first wall of the at least one frame is located between the first and second plates, and the at least one cover is connected to the at least one frame and the ridge is located within the at least one notch of the at least one frame and engaged with the at least one slot of the at least one cover.

The primary object of the present invention is to provide a light assembly wherein the clamping members are connect the frame and the cover firmly and the clamping members do not loose.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the light assembly of the present invention;

FIG. 2 is a perspective view to show the clamping member of the present invention;

FIG. 3 is a perspective view to show the clamping member of the present invention from another angle;

FIG. 4 is a perspective view to show that the covers are connected to the frames of the light housing by the clamping members of the present invention;

FIG. 5 is a plane view to show that the covers are connected to the frames of the light housing by the clamping members of the present invention;

FIG. 6 is a cross sectional view taken along line A-A in FIG. 5, and

FIG. 7 is a cross sectional view taken along line B-B in FIG. 5.

### DETAILED DESCRIPTION OF THE PREFERRED EMBODIMENT

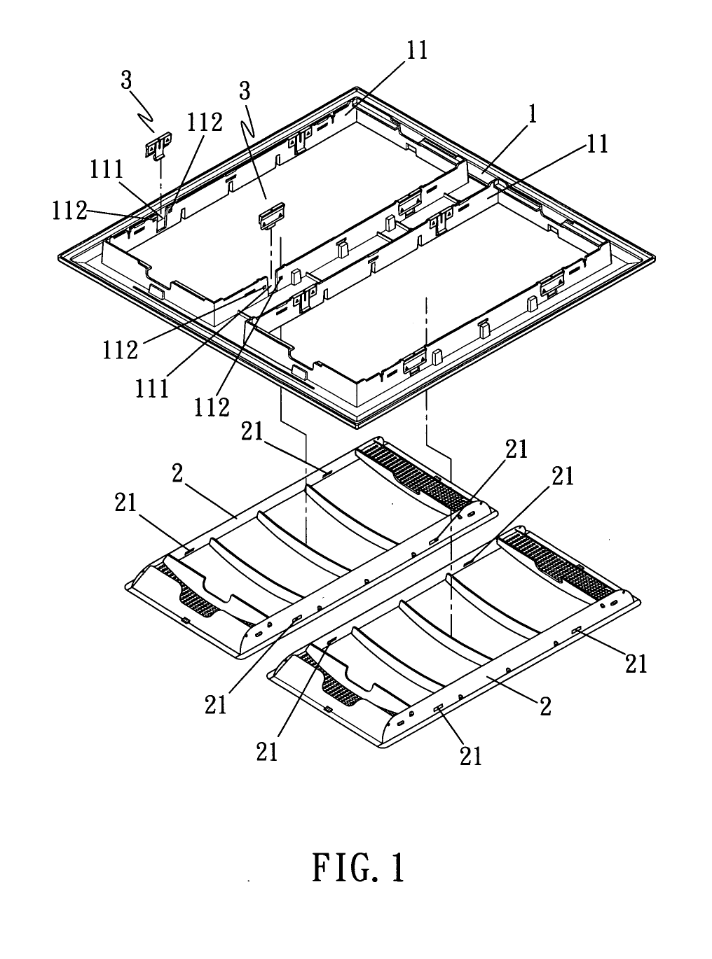

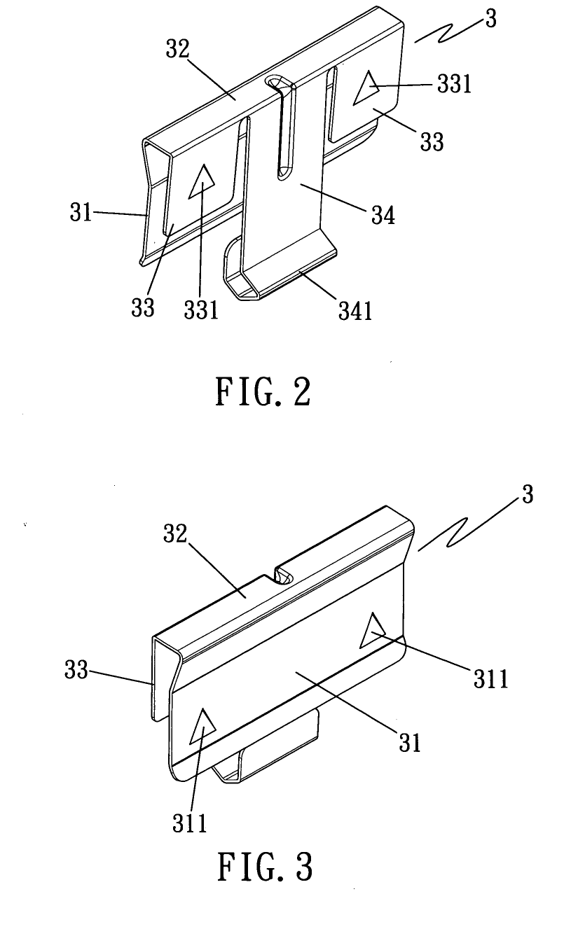

Referring to FIGS. 1 to 3, the light assembly of the present invention comprises a housing 1 including two rectangular frames 11 connected thereto and each of the frames 11 includes two long first walls and two short first walls. Each of the two long first walls has two notches 111 defined therein and each of the two long first walls includes multiple recesses 112 defined in an inside and an outside thereof respectively. The notch 111 is located between the recesses 112 corresponding thereto.

Two covers 2 are connected to the two frames 11 and each cover 2 includes two second walls and each second wall includes two slots 21 defined therethrough.

Multiple clamping members 3 are used to connect the covers 2 to the frames 11. Each clamping member 3 includes a first plate 31, two second plates 33 and a connection portion 32 which is connected between two respective ends of the first and second plates 31, 33. A gap is defined between the first plate 31 and the two second plates 33. A positioning plate 34 extends from the connection portion 32 and located between the two second plates 33. A ridge 341 extends from a side of the positioning plate 34 and protrudes toward a direction away from the first and second plates 31, 33.

The first plate 31 has two first stubs 311 extending into the gap and a tip of each of the two first stubs 311 points the connection portion 32. The two second plates 33 each have a second stub 331 extending into the gap and a tip of each of the second stubs 331 points the connection portion 32.

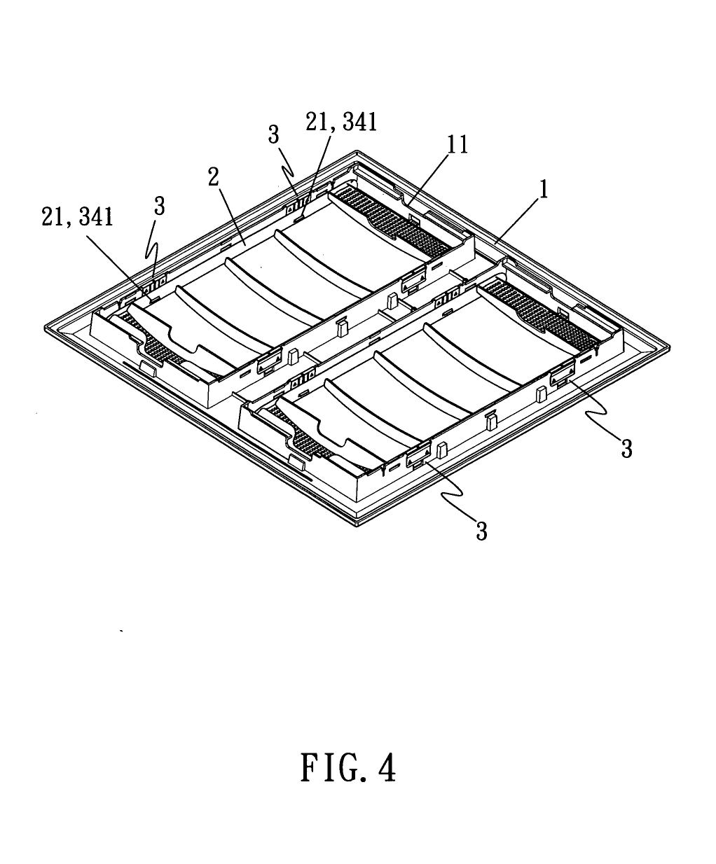

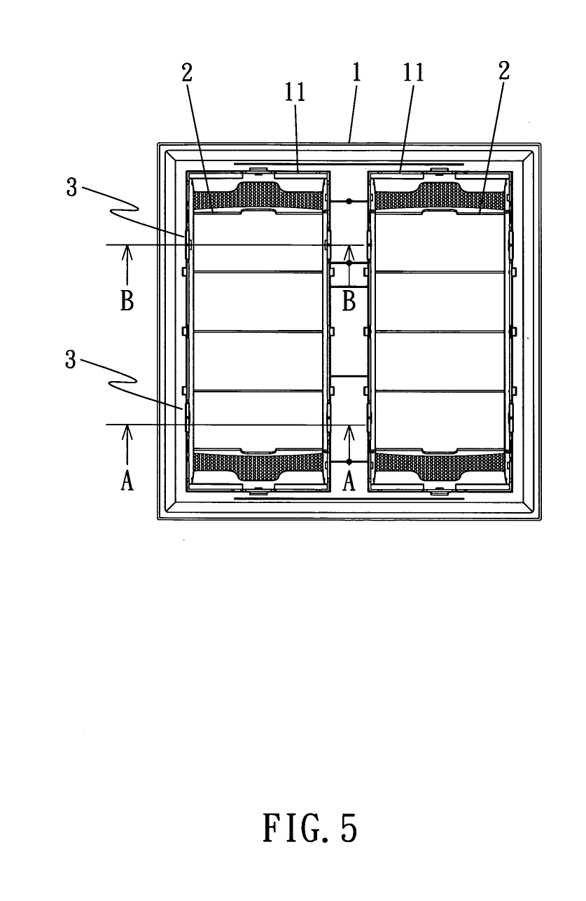

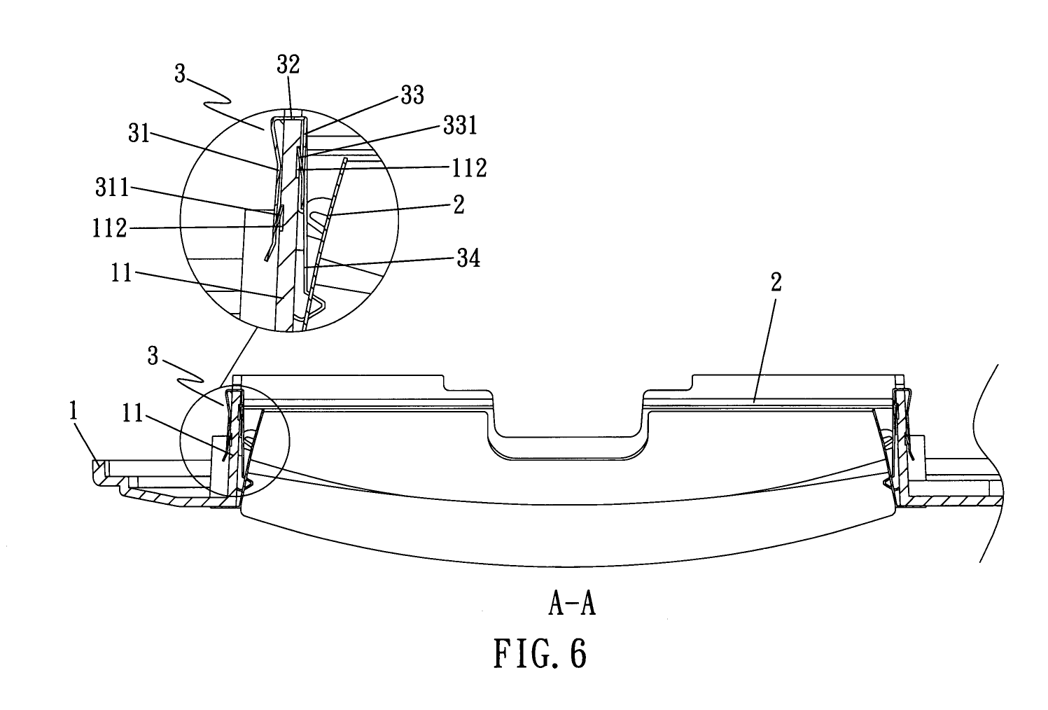

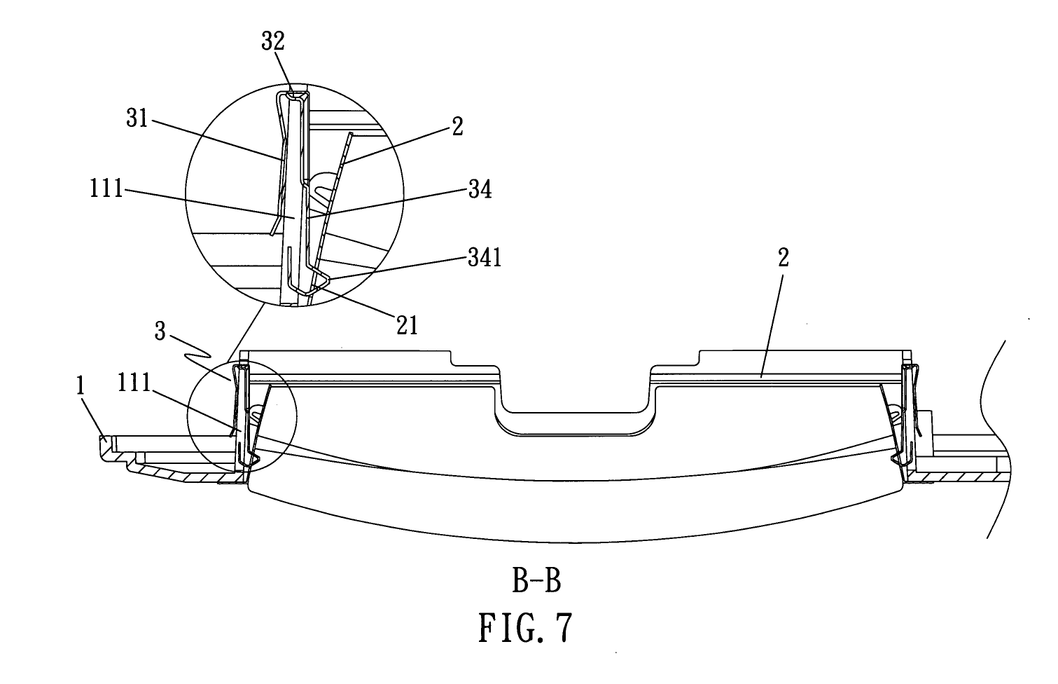

Referring to FIGS. 4 to 7, the long first walls of each frame 11 are located between the first and second plates 31, 33 of the clamping members 3, the first stubs 311 the second stubs 331 are engaged with the recesses 112 in the inside and outside of the long first walls of each of the frames 11. The covers 2 are then connected to the frames 11 and the second walls of the covers 2 push the positioning plates 34 when moving over the ridges 341, the ridges 341 are then engaged with the slots 21 in the second walls after the ridges 341 are located in alignment with the slots 21 by the bouncing force of the positioning plates 34.

It is noted that the tips of the first and second stubs 311, 331 of the clamping members 3 are securely engaged with the recesses 112 of the long first walls of the frames 11 so as to prevent the clamping members 3 from disengaging from the long first walls. In other words, when a force such as the gravity force applies to the clamping members 3 to remove the clamping members 3 from the long first walls, the tips of the first and second stubs 311, 331 of the clamping members 3 stop the separation of the clamping members 3 to fall down. The clamping members 3 are securely connected to the long first walls ensure that the covers 2 are well positioned to the frames 11 by the clamping members 3.

While we have shown and described the embodiment in accordance with the present invention, it should be clear to those skilled in the art that further embodiments may be made without departing from the scope of the present invention.

What is claimed is:

1. A light assembly comprising:
a housing including at least one frame connected thereto and the at least one frame including at least one first wall, the at least one first wall having at least one notch defined therein;
at least one cover including at least one second wall which includes at least one slot, and
at least one clamping member including a first plate, two second plates and a connection portion connected between two respective ends of the first and second plates, a gap defined between the first plate and the two second plates, a positioning plate extending from the connection portion and located between the two second plates, a ridge extending from a side thereof, the at least one first wall of the at least one frame located between the first and second plates, the at least one cover connected to the at least one frame and the ridge located within the at least one notch of the at least one frame and engaged with the at least one slot of the at least one cover.

2. The assembly as claimed in claim 1, wherein the first plate has at least one first stub extending into the gap and a tip of the at least one first stub points the connection portion, the two second plates each have at least one second stub extending into the gap and a tip of each of the at least one second stub points the connection portion, the at least one first wall of the at least one frame includes at least one recess defined in each of an inside and an outside thereof respectively, the at least one first stub the at least one second stub are engaged with the at least one recess in the inside and outside of the at least one first wall of the at least one frame.
